(19) United States
(12) Patent Application Publication
(10) Pub. No.: US 2026/0007503 A1
(43) Pub. Date: Jan. 8, 2026

(54) TWO-FINGER CAP CLEANING FABRIC WITH DENTAL FLOSS

(71) Applicant: OIMO INDUSTRIAL COMPANY LTD., Taipei City (TW)

(72) Inventor: Pai-Yung LIN, Taipei City (TW)

(21) Appl. No.: 18/765,532

(22) Filed: Jul. 8, 2024

(51) Int. Cl. A61C 15/04

(52) U.S. Cl. CPC A61C 15/046

(57) ABSTRACT

A two-finger cap cleaning fabric with dental floss, which includes: a contact fabric piece, a first cover fabric, a second cover fabric, and a floss, the main function of which involves placing the index finger into a first finger cap space between the first cover fabric and the contact fabric piece, and inserting the thumb into a second finger cap space between the second cover fabric and the contact fabric piece, whereby the user is then able to use their index finger and thumb to control the contact fabric piece to proceed with cleaning the teeth. In addition, one end of the floss inside a folded over portion of the second cover fabric can be detached, thereby enabling cleaning the teeth with the floss.

### BACKGROUND OF THE INVENTION

### Field of the Invention

The present invention relates to a two-finger cap cleaning fabric with dental floss, and more particularly to a cleaning fabric structure for use in cleaning teeth.

### Description of the Prior Art

Oral hygiene is vitally important, being mainly directed towards cleaning the teeth and tongue, whereby only after removing residual food particles and foreign matter can a person maintain oral health. Currently, the most commonly used cleaning tool is the toothbrush. The main usage mode of which involves applying toothpaste to the brush part of the toothbrush, and using the brush part to proceed with cleaning the teeth. However, apart from the relative bother of having to take along the toothbrush when travelling, toothpaste must also be used together with the toothbrush, and thus inconvenient in use. Therefore, toothpicks and dental floss are more convenient options. The main purpose of which is to use the end tip of the toothpick to clean the teeth, whereas the thread of the dental floss is used to clean the teeth. However, the toothpick and dental floss can only remove residual food particles and foreign matter remaining between the teeth, and cannot clean the surfaces of the teeth and tongue. Hence, it is the purpose of the present invention to improve upon the above-described shortcomings, and is the difficult technical problem the inventor of the present invention intends to resolve.

### SUMMARY OF THE INVENTION

The main object of the present invention lies in: assembling a contact fabric piece, a first cover fabric, a second cover fabric, and a floss; the main function of which involves the user inserting their index finger into a first finger cap space between the first cover fabric and the contact fabric piece, and inserting their thumb into a second finger cap space between the second cover fabric and the contact fabric piece, thereby enabling the user to use their index finger and thumb to control the contact fabric piece to proceed with cleaning the teeth. In addition, one end of the floss inside a folded over portion of the second cover fabric can be detached, to enable cleaning between the teeth therewith.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a three-dimensional external view of the present invention.

FIG. 2 is a three-dimensional exploded view of the present invention.

FIG. 3 is a perspective view of the present invention.

FIG. 4 is a first schematic view of a preferred embodiment of the present invention in use.

FIG. 5 is a second schematic view of the preferred embodiment of the present invention.

### DETAILED DESCRIPTION OF THE PREFERRED EMBODIMENTS

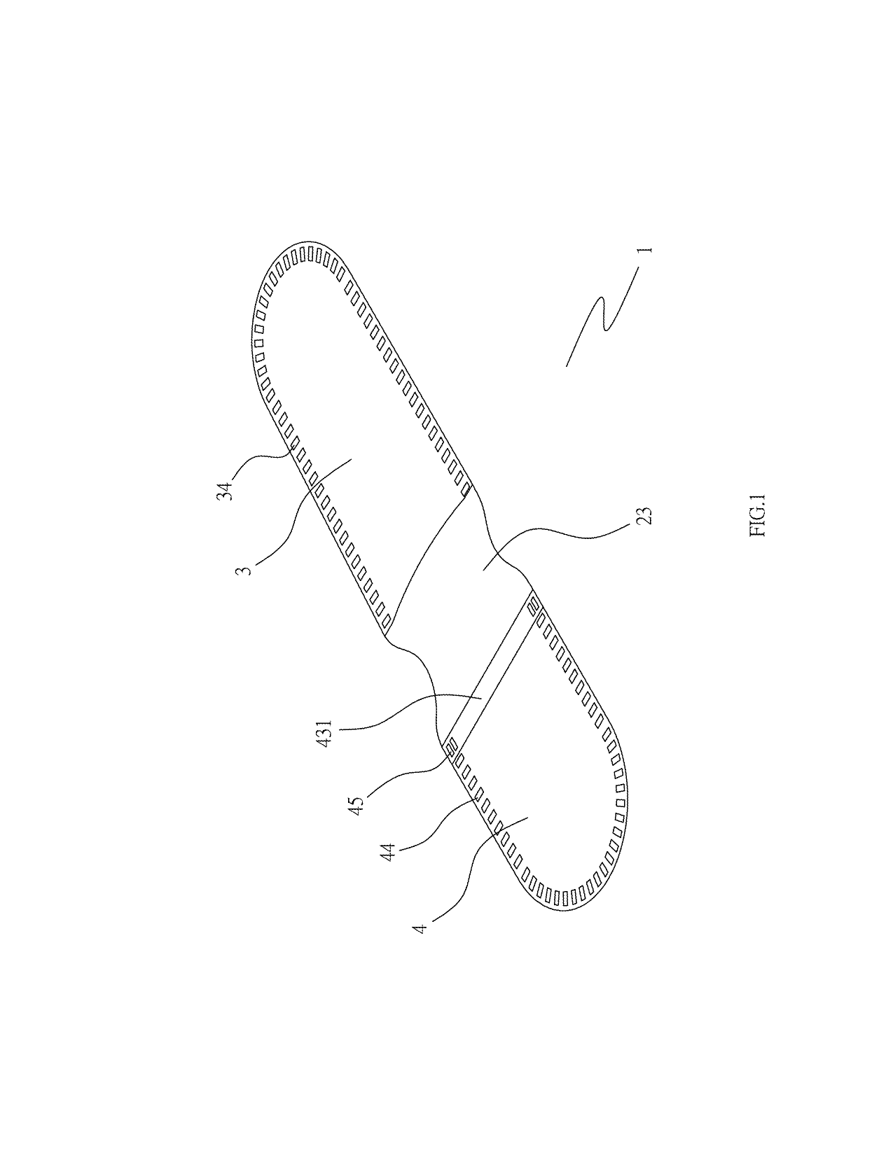

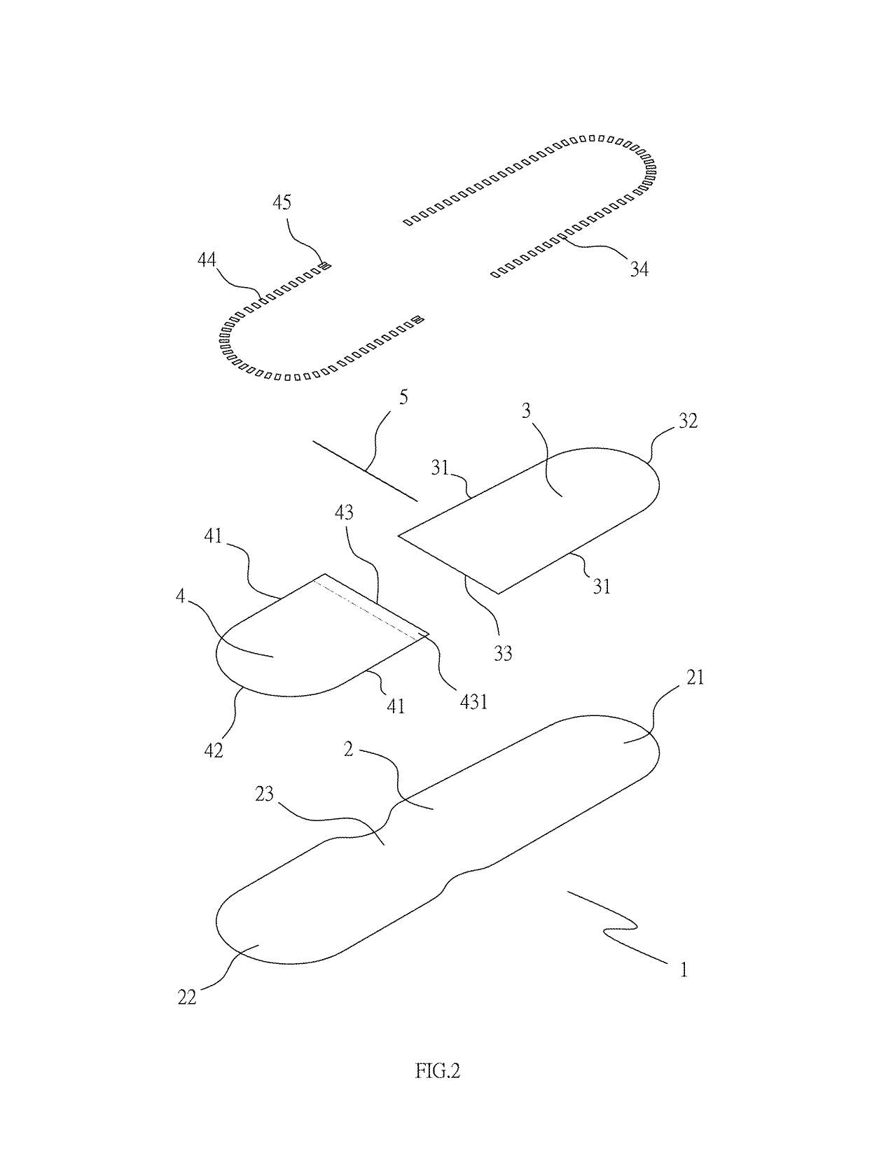

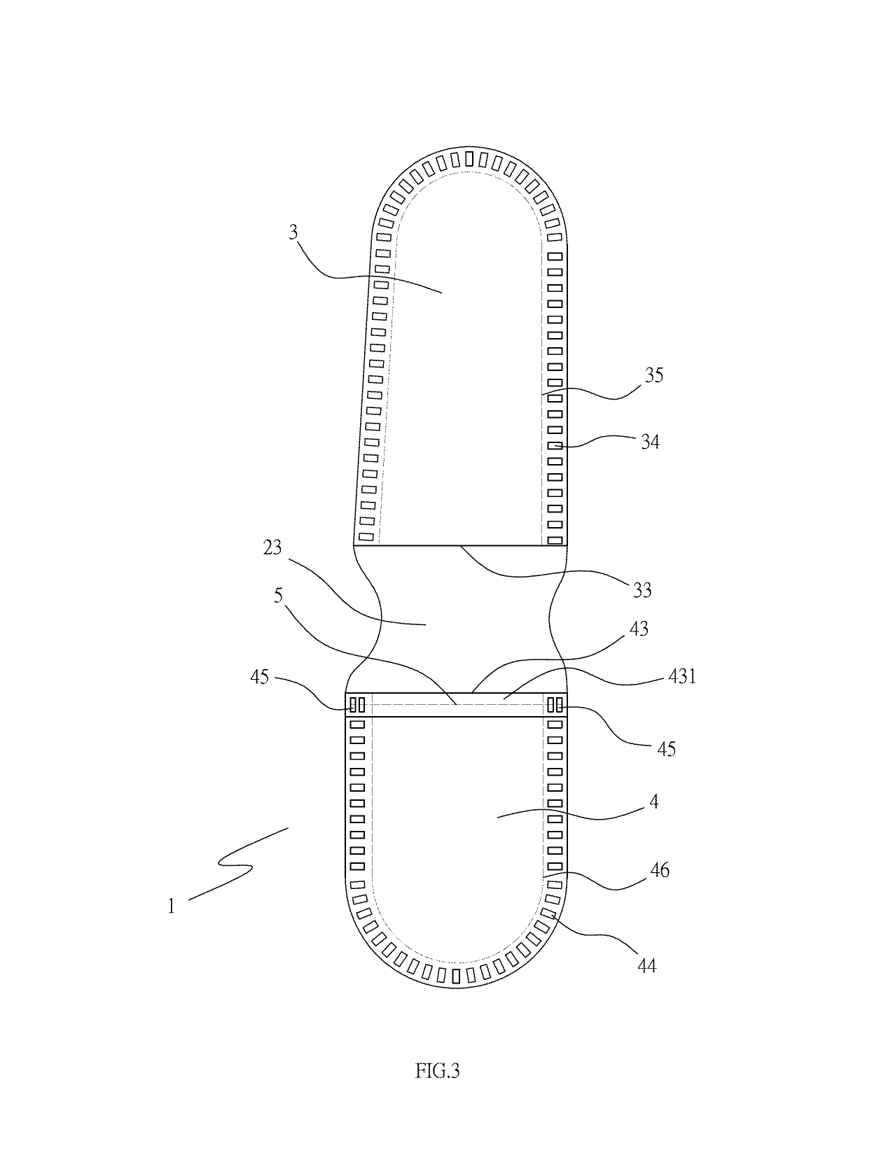

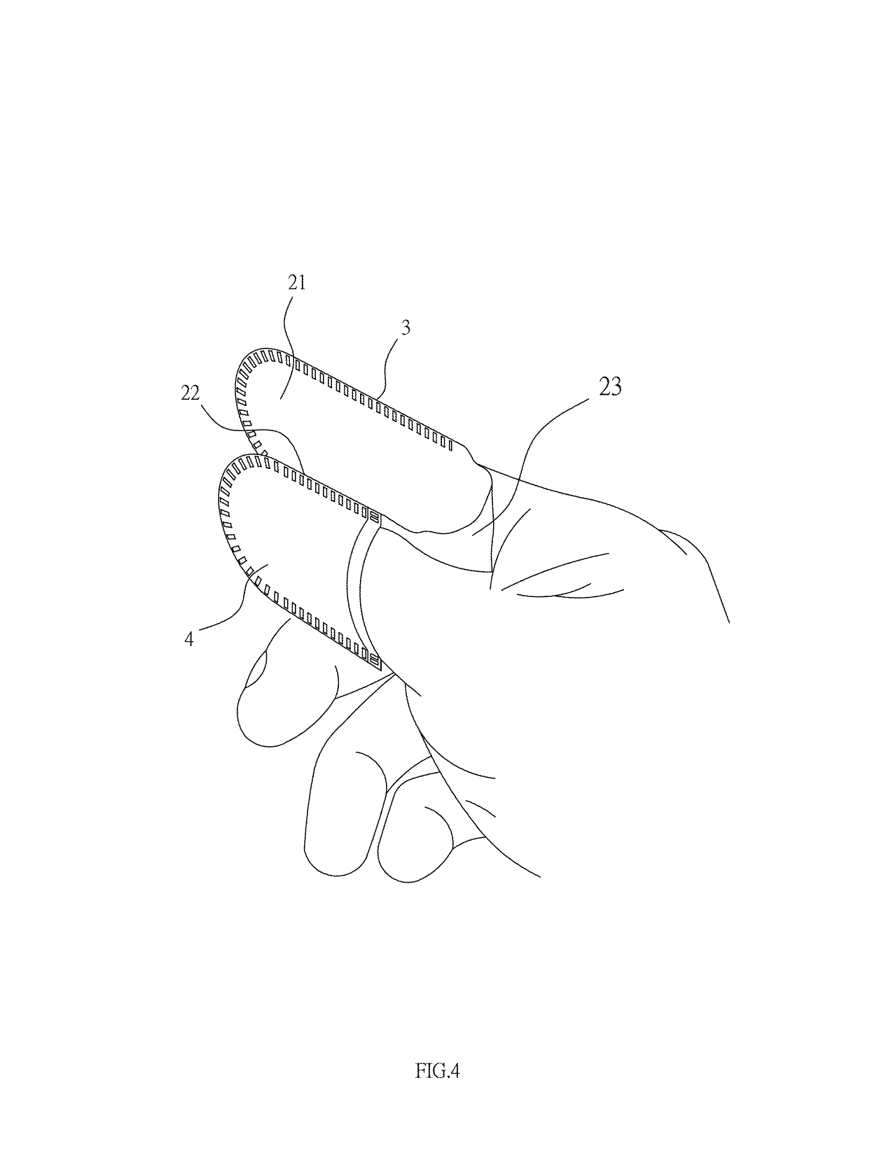

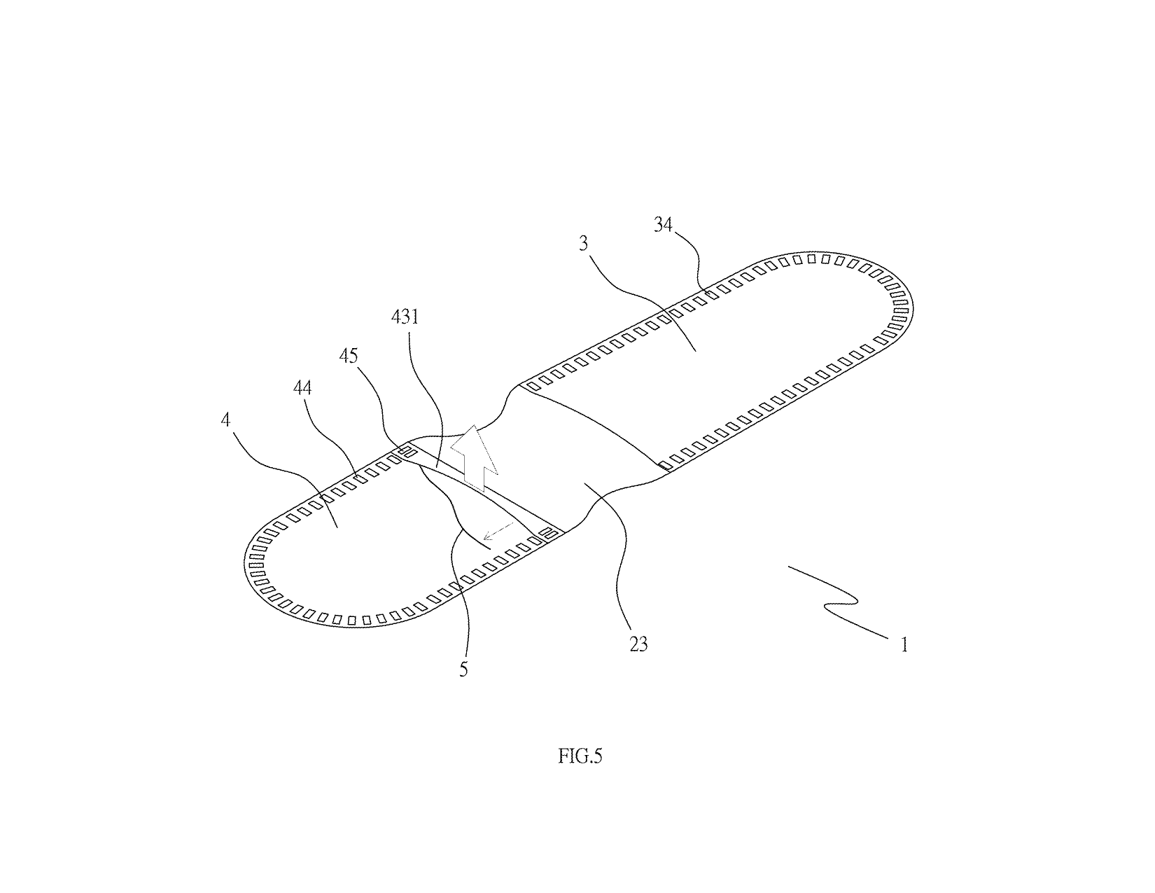

Referring to FIGS. 1, 2, 3, 4 , and FIG. 5 , which show a three-dimensional external view, a three-dimensional exploded view, a perspective view, and schematic views of a preferred embodiment of the present invention, and it can be clearly seen from the drawings that a two-finger cap cleaning fabric with dental floss 1 of the present invention comprises: a contact fabric piece 2, provided with a first cleaning portion 21, a second cleaning portion 22, and a connecting portion 23, wherein the connecting portion 23 is used to connect the first cleaning portion 21 and the second cleaning portion 22; a first cover fabric 3, configured on the first cleaning portion 21, thereby forming a first finger cap space 35 between the first cleaning portion 21 of the contact fabric piece 2 and the first cover fabric 3; the first cover fabric 3 is provided with two corresponding first long sides 31, a first end side 32, and a first opening side 33, wherein a plurality of joining hot melt threads 34 are configured on the first long sides 31 and the first end side 32; a second cover fabric 4, configured on the second cleaning portion 22, thereby forming a second finger cap space 46 between the second cleaning portion 22 of the contact fabric piece 2 and the second cover fabric 4; the second cover fabric 4 is provided with two corresponding second long sides 41, a second end side 42, and a second opening side 43, wherein a plurality of joining hot melt threads 44 are configured on the long sides 41 and the end side 42, and the second opening side 43 is configured with a folded over portion 431; and a floss 5, configured inside the folded over portion 431 of the second opening side 43 of the second cover fabric 4.

The connecting portion 23 of the contact fabric piece 2 is a contracted form.

The length of the first cleaning portion 21 is greater than that of the second cleaning portion 22.

The width of the second cleaning portion 22 is greater than that of the first cleaning portion 21.

The length of the first cover fabric 3 is greater than that of the second cover fabric 4.

The width of the second cover fabric 4 is greater than that of the first cover fabric 3.

A plurality of fixing hot melt threads 45 are configured on two corresponding ends of the folded over portion 431, wherein the fixing hot melt threads 45 are used to fix the two ends of the floss 5.

When in use, the main function of the present invention involves the user inserting their index finger into the first finger cap space 35 formed between the first cover fabric 3 and the first cleaning portion 21 of the contact fabric piece 2, and inserting their thumb into the second finger cap space 46 formed between the second cover fabric 4 and the second cleaning portion 22 of the contact fabric piece 2, whereby the user is then able to use their index finger and thumb to control the first cleaning portion 21 and the second cleaning portion 22 of the contact fabric piece 2 to proceed with cleaning the surfaces of the teeth or tongue.

In addition, the first cleaning portion 21 and the second cleaning portion 22 are connected by means of the connecting portion 23, the main function of which is to enable the first cleaning portion 21 and the second cleaning portion 22 to mutually restrain each other, thereby preventing the index finger and thumb from separating from the first finger cap space 35 and the second finger cap space 46 during the cleaning action of the teeth. Moreover, the configuration of the connecting portion 23 further covers the gap between the thumb and the index finger to prevent bacteria and dirt from contaminating the gap between the thumb and the index finger when in use.

Further, when needing to use the floss 5 configured inside the folded over portion 431 of the second opening side 43 of the second cover fabric 4, the user only needs to lift open the folded over portion 431 to expose the floss 5 and detach one end of the floss 5 from the fixing hot melt thread 45; the other end being fixed by the other fixing hot melt thread 45. The user can then hold the detached end of the floss 5 to proceed with cleaning the teeth.

In conclusion, compared to the shortcomings and inconvenience of commonly used toothpicks and dental floss, through the distinctive design and configuration of the contact fabric piece 2, the first cover fabric 3, the second cover fabric 4, and the floss 5, the present invention enables the user to insert their index finger and thumb into the finger cap space 35 and the finger cap space 46, respectively, to quickly carry out cleaning the surfaces of the teeth and tongue. Furthermore, the design of the floss 5 can further achieve the object of cleaning between the teeth.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A two-finger cap cleaning fabric with dental floss, comprising:
a contact fabric piece, provided with a first cleaning portion, a second cleaning portion, and a connecting portion, wherein the connecting portion is used to connect the first cleaning portion and the second cleaning portion;
a first cover fabric, configured on the first cleaning portion, thereby forming a first finger cap space between the first cleaning portion of the contact fabric piece and the first cover fabric; the first cover fabric is provided with two corresponding first long sides, a first end side, and a first opening side, wherein a plurality of joining hot melt threads are configured on the first long sides and the first end side;
a second cover fabric, configured on the second cleaning portion, thereby forming a second finger cap space between the second cleaning portion of the contact fabric piece and the second cover fabric; the second cover fabric is provided with two corresponding second long sides, a second end side, and a second opening side, wherein a plurality of joining hot melt threads are configured on the second long sides and the second end side, and the opening side is configured with a folded over portion; and
a floss, configured inside the folded over portion of the opening side of the second cover fabric.

2. The two-finger cap cleaning fabric with dental floss according to claim 1, wherein the connecting portion of the contact fabric piece is a contracted form.

3. The two-finger cap cleaning fabric with dental floss according to claim 1, wherein the length of the first cleaning portion is greater than that of the second cleaning portion.

4. The two-finger cap cleaning fabric with dental floss according to claim 1, wherein the width of the second cleaning portion is greater than that of the first cleaning portion.

5. The two-finger cap cleaning fabric with dental floss according to claim 1, wherein the length of the first cover fabric is greater than that of the second cover fabric.

6. The two-finger cap cleaning fabric with dental floss according to claim 1, wherein the width of the second cover fabric is greater than that of the first cover fabric.

7. The two-finger cap cleaning fabric with dental floss according to claim 1, wherein a plurality of fixing hot melt threads are configured on two corresponding sides of the folded over portion, and the fixing hot melt threads are used to fix the two ends of the floss.
